(19) United States
(12) Patent Application Publication
(10) Pub. No.: US 2003/0091290 A1
(43) Pub. Date: May 15, 2003

(54) Optical fiber right angle transition

(76) Inventor: N. Peter Whitehead, Richmond, VA (US)

Correspondence Address: ROBERTS ABOKHAIR & MARDULA, SUITE 1000, 11800 SUNRISE VALLEY DRIVE, RESTON, VA, 20191, US

(21) Appl. No.: 10/179,757

(22) Filed: Jun. 25, 2002

Related U.S. Application Data
(60) Provisional application No. 60/300,656, filed on Jun. 25, 2001.

(51) Int. Cl. G02B 6/26

(52) U.S. Cl. 385/50; 385/44

(57) ABSTRACT

A fiber optic right angle transition is formed via anisotropic etching of single crystal silicon. The fiber optic right angle transition includes a substantially planar mirror surface, a first V-groove, and a second V-groove, each formed in a silicon substrate. The first V-groove, along a first longitudinal axis, and the second V-groove, along a second longitudinal axis, are at right angles to one another. The mirror surface is substantially planar and intersects both the first longitudinal axis and the second longitudinal axis at an angle of 45 degrees. The first and second V-grooves are each adapted to receive an optical fiber. The optical signal exits one optical fiber, is reflected by the mirror and enters the other optical fiber, thereby effecting a right angle transition.

### CROSS REFERENCE TO RELATED APPLICATIONS

This application claims benefit under 35 U.S.C. § 119(e) of provisional application No. 60/300,656, filed Jun. 25, 2001. The 60/300,656 provisional application is incorporated by reference herein, in its entirety, for all purposes.

### INTRODUCTION

The present invention relates generally to the field of to optical fibers as employed in communications. More particularly, the present invention relates to performing a 90 degree spatial transition of an optical fiber within a limited amount of space.

### BACKGROUND OF THE INVENTION

Optical fiber as used in standard telecommunications and other applications is based upon the principles of Snell's Law and total internal reflection. Each fiber is made up of a central core and an outer layer known as the cladding. By establishing a core with an index of refraction (n) higher that the index of refraction of the cladding, the light will totally reflect internally rather than passing through the core and being lost.

Optical fiber connectors are made possible through the employment of a device known as a ferrule. This device supports and aligns the fiber allowing for a precise coupling of one fiber to another when the connection is made. In the case of a single fiber connector, the ferrule is a cylindrically shaped structure, often ceramic, which holds the fiber in its center with the aid of cured epoxy resin. The end of the fiber and the ferrule are polished to create an optically smooth, large planar surface with the optical fiber aligned as close as possible to the center of the device. When two keyed ferrules are aligned end to end through a mechanical connector, optical coupling takes place between the two fibers allowing the optical connection to be made. Often, the joining ferrule surfaces are not orthogonal in order to reduce unwanted reflection.

Multiple fiber connectors employ a ferrule that is generally rectangular in shape with groves or holes allowing for precise alignment of a plurality of fibers. These fibers are supported in a single, parallel array, separated by 250 microns on center.

Optical fiber as used in standard telecommunications and other applications is limited by its physical structure in its ability to make a right angle transition. Physically bending the fiber causes strain, which leads to fractures and structural imbalances in the fiber material. Such bends also cause the signal bearing light within the fiber to reflect out of the fiber resulting in power losses unacceptable to most systems. In electronic devices employed for fiberoptic communications, space must be allowed and special considerations made to accommodate the minimum bend radius of the optical fiber.

Thus, what is needed is a way to make an abrupt right angle bend for an optical fiber.

### SUMMARY OF THE INVENTION

It is in view of the above problems that the present invention was developed.

The invention thus has as an object to provide a method for establishing a 90-degree spatial transition for an optical link carried within optical fiber. It is also the object of this invention to provide a means of constructing a right angle fiber optic connector for single and multiple fibers.

### BRIEF DESCRIPTION OF THE DRAWING

Additional objects and advantages of the present invention will be apparent in the following detailed description read in conjunction with the accompanying drawing figures.

FIG. 1 illustrates a schematic view of a right angle bend according to a single fiber embodiment of the present invention.

FIG. 2 illustrates a schematic view of a right angle bend according to another embodiment of the present invention that provides for multiple fibers.

### DETAILED DESCRIPTION

The present invention may be embodied as a fiber optic right angle transition. The fiber optic right angle transition includes a substantially planar mirror surface, a first V-groove, and a second V-groove, each formed in a silicon substrate. The first V-groove, along a first longitudinal axis, and the second V-groove, along a second longitudinal axis, are at right angles to one another. The mirror surface is substantially planar and intersects both the first longitudinal axis and the second longitudinal axis at an angle of 45 degrees. The first and second V-grooves are each adapted to receive an optical fiber.

Crystalline silicon is precisely machinable at a microscopic level by means of chemical etching and the natural crystalline structure. This crystalline structure is mapped through the employment of simple Cartesian axes and lattice orientation indicators known as the Miller indices.

One method of silicon crystal machining is known as wet bulk machining. Using anisotropic etchants whose etching rates depend upon the crystallographic orientation, the single crystal can be precisely machined along the planes dictated by the Miller indices creating patterns with virtually planar sidewalls. This property allows consistent, precise alignment of parallel structures as well as precisely orthogonal and 45-degree machining. It also allows the etching of vertical microscopic mirrors that are without need of polishing. This manufacturing technology is commonly employed in the construction of Micro Electromechanical Machines (MEMs). V-grooves constructed in this manner have been proven as reliable devices for precisely aligning optical fibers in devices such as MEMs switches.

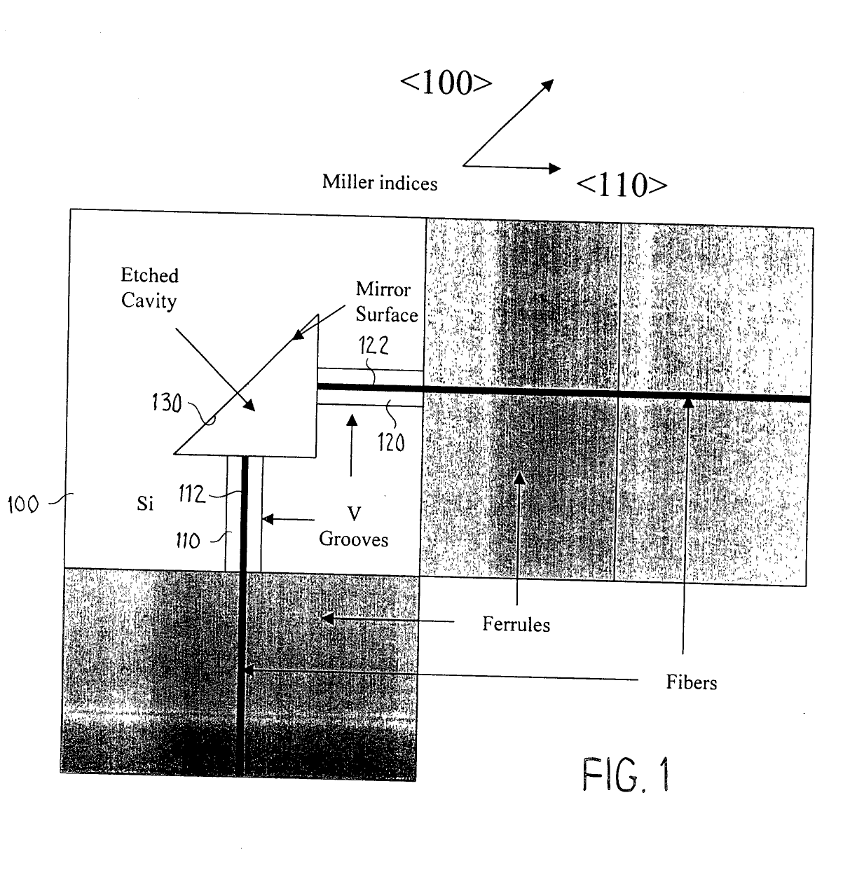

Referring to FIG. 1, a scheme is illustrated for constructing an easily manufactured fiber optic 90 degree transition. This right angle transition consists of a machined silicon crystal 100 containing two V-grooves 110, 120 for alignment of the input fiber 112 and output fiber 122 and a machined mirror 130 that is precisely aligned at 45 degrees to both fibers 112, 122 by the Miller indices of the crystal and the machining process. In this example, one of the V-grooves 110 is aligned with the [1,1,0] crystal axis, the other V-groove 120 is aligned with the [−1,1,0] crystal axis, and the plane of the machined mirror is parallel to the [1,0,0] crystal axis. In the application of this 90 degree transition in the form of a mechanical connector, a standard ferrule is applied at each end of the crystal to support the fibers and allow the connector transition.

Alternatively, one of the V-grooves 110 maybe aligned with the [1,0,0] crystal axis, the other V-groove 120 aligned with the [0,1,0] crystal axis, and the plane of the machined mirror being normal to the [1,1,0] crystal axis.

It is noted that the nomination of one fiber as the “input” fiber and the other as the “output” fiber is somewhat arbitrary since information typically flows bi-directionally through the fibers.

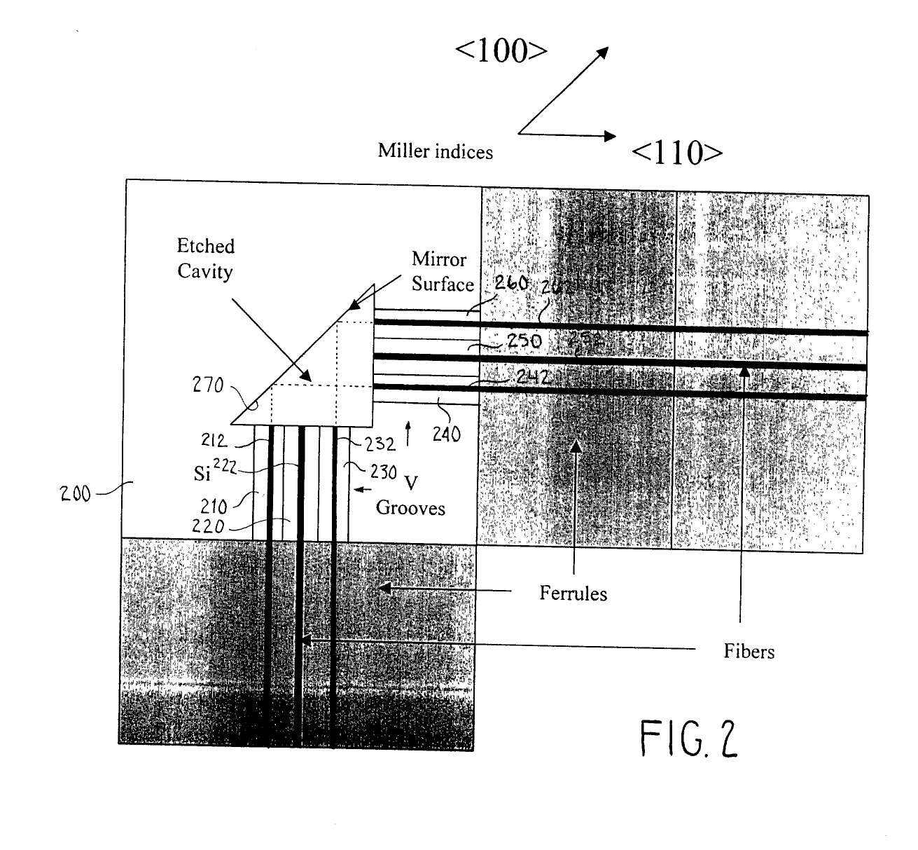

Referring to FIG. 2, a schematic view of a right angle bend according to another embodiment of the present invention is illustrated that provides for multiple fibers. This right angle transition is machined in a silicon crystal 200 containing three V-grooves 210, 220, 230 for alignment of the input fibers 212, 222, 232 and three V-grooves 240, 250, 260 for alignment of the output fiber 242, 252, 262. A mirror 270 is machined into the silicon crystal such that it is precisely aligned at 45 degrees to the fibers 212, 222, 232, 242, 252, 262 according to the Miller indices of the crystal and the machining process.

The ends of the fibers may be prepared according to a variety of methods. A graded index (GRIN) lens has been found to be suitable. Alternatively, a fused fiber tip may be used and would be much cheaper to manufacture than the GRIN lens termination.

The present invention has been described in terms of preferred embodiments, however, it will be appreciated that various modifications and improvements may be made to the described embodiments without departing from the scope of the invention.

What is claimed is:

1. A fiber optic right angle transition comprising:
a substantially planar mirror surface formed in a silicon substrate;
a first V-groove formed in the silicon substrate along a first longitudinal axis; and
a second V-groove formed in the silicon substrate along a second longitudinal axis;
wherein the first longitudinal axis and the second longitudinal axis are at right angles to one another, wherein the mirror surface intersects the first longitudinal axis at an angle of 45 degrees, and wherein the mirror surface intersects the second longitudinal axis at an angle of 45 degrees.

2. The fiber optic right angle transition as claimed in claim 1, wherein the first and second V-grooves are each adapted to receive an optical fiber.

3. The fiber optic right angle transition as claimed in claim 1, wherein the first and second V-grooves are formed via anisotropic etch.

4. The fiber optic right angle transition as claimed in claim 1, wherein the mirror surface is formed via anisotropic etch.
